(19) United States
(12) Patent Application Publication
(10) Pub. No.: US 2011/0022409 A1
(43) Pub. Date: Jan. 27, 2011

(54) Patient Admission Tracking System

(76) Inventor: Elizabeth Harrah, Canton, GA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/843,798

(22) Filed: Jul. 26, 2010

Related U.S. Application Data
(60) Provisional application No. 61/228,352, filed on Jul. 24, 2009.

(51) Int. Cl. G06Q 50/00; G06Q 10/00

(52) U.S. Cl. 705/2

(57) ABSTRACT

An emergency room tracking system that allows a medical treatment facility official or charge nurse to maintain and notate pertinent information relating to a patient from the moment the patient enters the emergency room until that patient is admitted to the hospital. A unitary spreadsheet display containing specific rows and boxes for multiple patients is used as the official conducts a method of data entry and notation at specified events. In this manner, the spreadsheet will identify sources of emergency room bottlenecks and other problems related to the flow of the emergency care facility.

### CONTINUITY DATA

This is a non-provisional patent application claiming priority to U.S. provisional patent application No. 61/228,352, filed on Jul. 24, 2009.

### FIELD OF THE PRESENT INVENTION

The present invention relates to a tracking system that permits a user to enter specific data entries onto a unitary spreadsheet on a computing device such as a server or conventional computer hardware in a manner that provides immediate information regarding the status and individual circumstance of individual admitted patients, and identifies sources of emergency room bottlenecks as well.

### BACKGROUND OF THE PRESENT INVENTION

The emergency room of a medical care facility is known as an exceptionally chaotic place. Human beings of varying degrees of distress are admitted into a situation with a large number of moving parts and people. This means that coordination and consistent flow of patients is critical in achieving the proper care for those patients admitted. This requires patients, doctors, nurses, and supervisors to go along with procedures such as special needs, room assignments, time commitments and order transmission. Moreover, the ideal maximum amount of time to admit a patient into the hospital from his or her initial admission into the emergency room is 59 minutes. As such, there is a need for an extremely efficient and user-friendly system that tracks these patients as they are navigated through the process.

According to a recent National Hospital Ambulatory Medical Care Survey, about 119.2 million people visit an emergency room each year in the United States. About 42.4 million of these patients are there due to an injury-related ailment. Typically, only about 13 percent of all emergency room patients are actually admitted into the hospital, with a small percentage needing to be transferred to a different hospital for specialized care. But whether the patient enters the emergency room for something minor or severe, the moving parts of the medical treatment facility must assess and move each person in a prudent and expeditious manner. In fact, the same study revealed that only 22 percent of all patients were seen within the first 15 minutes of admission. Meanwhile, the median time spent in an emergency department was 2.6 hours. In that regard, there is a need for a system that can not only track each patient as they move through the process, but also provide a user-friendly and reliable means of identifying bottlenecks and other delays, as well as the causes of such problems. The present invention solves these needs by implementing a system that permits a user to enter specific data entries onto a unitary spreadsheet or computing device in a manner that provides immediate information regarding the status and individual circumstance of individual admitted patients as well as identify sources of emergency room bottlenecks.

Another factor relating to an emergency room is that the nurses and staff are constantly working in an extremely fast-paced environment. This includes active involvement and engagement with the patients. As such, it is often difficult for a nurse or charge nurse to refer back to a computer screen, as is necessary in many current systems. In addition, it is unrealistic for a nurse to carry a laptop. The rationale is that technology often produces glitches related to power, operator error or other technical problems. Such issues and reliance on these elaborate systems have the proven result of causing delays and confusion in the patient tracking process of the emergency room, which carries over toward the hospital admissions process. A typical attempt to resolve these issues is to provide a whiteboard so that data can be tracked such as the number of patients seen, ages, etc. While whiteboards and other similar means of data entry are relatively low-tech means of maintaining statistics, they do not maximize the novel effects of the present invention in terms of the actual process and problem identification in regard to admitting patients into the hospital from the emergency room.

U.S. Patent Application 2005/0209886 filed by Corkern on Sep. 22, 2005 is a system and method of tracking patient flow. Corkern employs radio-frequency identification (RFID) tags onto the patients and their charts so that an alert is made when too much time has elapsed. Unlike the present invention, Corkern merely tracks time in conjunction with the charts of the patients. In addition, U.S. Pat. No. 5,760,704 issued to Barton et al. on Jun. 2, 1998 also relies on similar types of alerts, as well as color codes, in order to track patients. In contrast, the present invention is a system for the charge nurse or official to not only be made instantly aware of the status of a patient, but the present invention also is configured and conducted such that the official can immediately recognize trends and delays occurring in real time throughout the emergency room.

U.S. Patent Application 2002/0072911 filed by Kilgore et al. on Jun. 13, 2002 is a system and method for interactively tracking a patient in a medical facility. Kilgore requires computer processing and other complex data elements in order to input patient information into the system. In contrast, the present invention is a system for the charge nurse or official to not only be made instantly aware of the status of a patient, but the present invention also is configured and conducted such that the official can immediately recognize trends and delays occurring in real time throughout the emergency room.

U.S. Patent Application 2006/0111941 filed by Blom on May 25, 2006 is an automated patient management system. Blom uses computer data entry means to monitor various aspects of a patient's care. Unlike the present invention, Blom requires multiple display screens to enter such data into its system. In contrast, the present invention provides a system and method that allows the official or charge nurse to easily gauge and track the patient's progress within the emergency room through notations made on one display screen. In addition, the present invention permits such tracking to occur on one display screen for multiple patients in a manner that allows for real-time tracking and problem identification.

The process of tracking and moving a patient through the emergency room is very important and difficult when taking the environment and nature of the situation into account. Existing methods attempt to track and manage data entry in ways that require multiple pages and reliance on computer systems. While these items may be good for long-term data management, they do not solve the immediate needs of the emergency room in regard to quick turnaround time and efficient flow of patient information. In addition, electronic alert systems may help a particular patient, but they do not solve the need to immediately and seamlessly identify where the actual trouble area is so that it can be rectified in real time. The present invention solves this need through its system and method of patient tracking.

### SUMMARY OF THE PRESENT INVENTION

The present invention is a tracking system for use in an emergency room facility. The present invention relates to a process that is undertaken by a charge nurse or other supervisory official during the course of patient admission to a medical treatment facility. This process involves placing specific information onto specified locations of a unitary spreadsheet or unitary display screen page. Information is recorded onto the spreadsheet or display screen page in such a manner that all relevant data regarding a patient is easily accessible and available via a unitary format. In addition, the recorded data is organized in such a specific manner that a supervisory official will use the process of the present invention to verify that all required steps and procedures are being met. This includes identifying blank spaces on the spreadsheet or display screen to learn where bottlenecks, delays or other problem areas are occurring.

### BRIEF DESCRIPTION OF THE DRAWINGS

FIG. 1 is a view of a spreadsheet display of the present invention

FIG. 2 is a flow chart of the method of the present invention

### DETAILED DESCRIPTION OF THE PREFERRED EMBODIMENT

The present invention is a tracking system that provides an official or employee of an emergency medical treatment facility the means to track all of the relevant data associated with a patient from the moment the patient is admitted into the emergency room and onto the point where the patient is admitted into the hospital for further care.

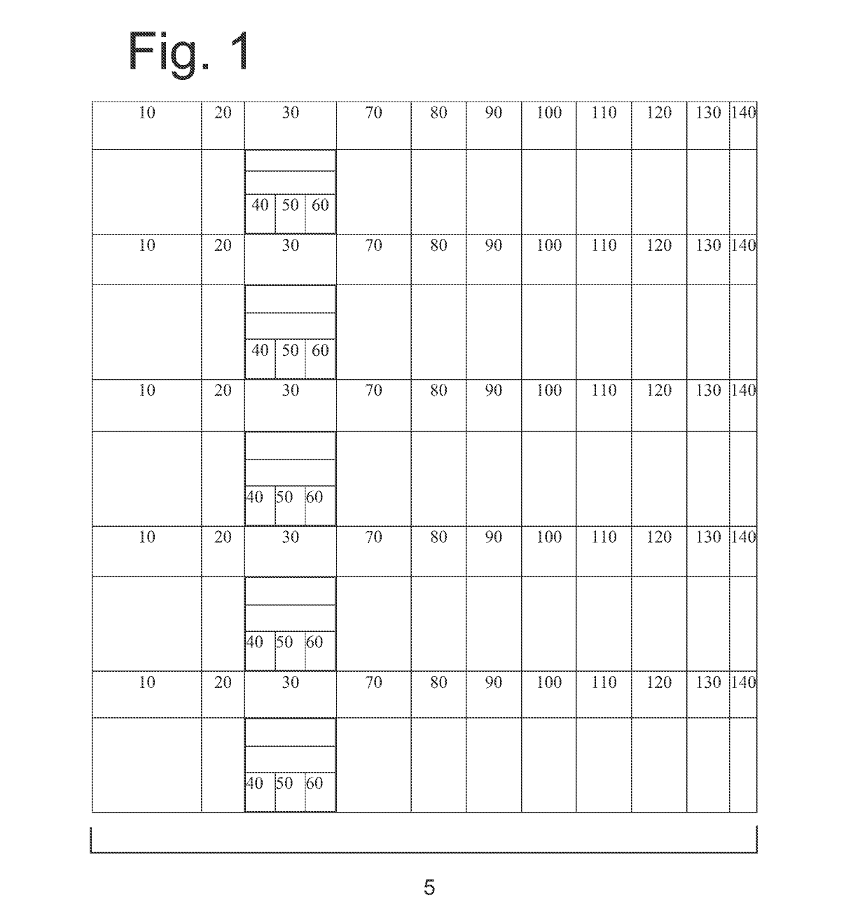

As we see in FIG. 1, the present invention is a system in which an emergency room official tracks important data relating to a patient who is admitted into an emergency room. Typically, the official is a charge nurse or supervisor that manages the patient care areas for the particular shift. The method of tracking is recorded onto a spreadsheet (5). The spreadsheet (5) of the present invention is contained, preferably, via a display screen on a computer. In the embodiment relating to the display screen, it is envisioned that the spreadsheet (5) is displayed via conventional means associated with a tablet computing or display device. In that manner, a stylus would work to record such information.

The spreadsheet (5) is formed to have specified boxes and rows so that the method of the present invention can be recorded. This method, coupled with the specific boxes and rows of the spreadsheet (5), are necessary so that the official can record data and identify problems in real time without the risk of technical failure. In addition, the spreadsheet (5) of the present invention is formed in such a way that multiple instances of patient information can be recorded on the same unitary display. This function serves to assist the official in determining problem areas and emergency room bottlenecks based on the placement of specific boxes and rows of the spreadsheet (5) display. For example, the spreadsheet (5) and method of the present invention are configured in such a way that multiple blanks for different patients will indicate that the emergency room (ER) doctor is admitting patients but there is a holdup in actually conducting the nurse supervisor (NS) call.

As we see in FIG. 1, the spreadsheet (5) contains a number of squares, or boxes, in which an official notates information. A patient sticker box (10) is for placement of a sticker indicating the patient's identity. An ER (emergency room) box (20) is marked to indicate where the patient is initially located. An admitting doctor/diagnosis/special needs box (30) is also available for notation, and contains three smaller boxes, these being a potential private room box (40), a CA/TB box (50), and a C-diff/MRSA box (60).

The potential private room box (40), CA/TB box (50), and C-diff/MRSA box (60) are checked if the patient has, or is suspected to have, a medical condition that requires a private room. The CA/TB box (5) is checked if a patient has, or is suspected to have, CA (cancer) or TB (tuberculosis). A patient with cancer needs a private room because he or she can be easily infected, and a patient with tuberculosis needs a private room because he or she can easily infect others. The C-diff/MRSA box (60) is checked if a patient has, or is suspected to have, C-diff (Clostridium difficile) or Methicillin-resistant Staphylococcus aureus (MRSA). C-diff is a bacteria that causes diarrhea and other intestinal disease, and MRSA is a bacterial infection highly resistant to antibiotics. A patient with either of these conditions needs a private room both to protect the patient as well as other patients.

Also on the spreadsheet (5) is a time admitted by ER doctor box (70), a time NS was called box (80), as well as a hospital room number assigned box (90) and a time hospital room was assigned box (100). Other boxes for notation by an official include a time admission orders were made box (110), as well as a time admission orders were faxed box (120) and a time the patient was transferred to the hospital floor box (130). The final box is a delay code box (140) that is marked when delays occur for the transfer to the hospital floor, which is the final point for hospital admission.

The method of the present invention allows an official to make such notations onto the spreadsheet (5) at the times when such events occur. In instances where such events do not occur, the resulting blank spaces on the spreadsheet (5) will help identify individual staff that may be overwhelmed or inefficient, as well as provide officials with the ability to analyze trends and better delegate personnel. The system and method of the present invention also permits an official the ability to ensure that no steps in the emergency admission process are missed. It is contemplated that when the spreadsheet (5) is displayed on a computer, the blank spaces on the spreadsheet—identifying that staff is overwhelmed or inefficient—will set off alarms or alerts so that no steps in the emergency admission process are missed.

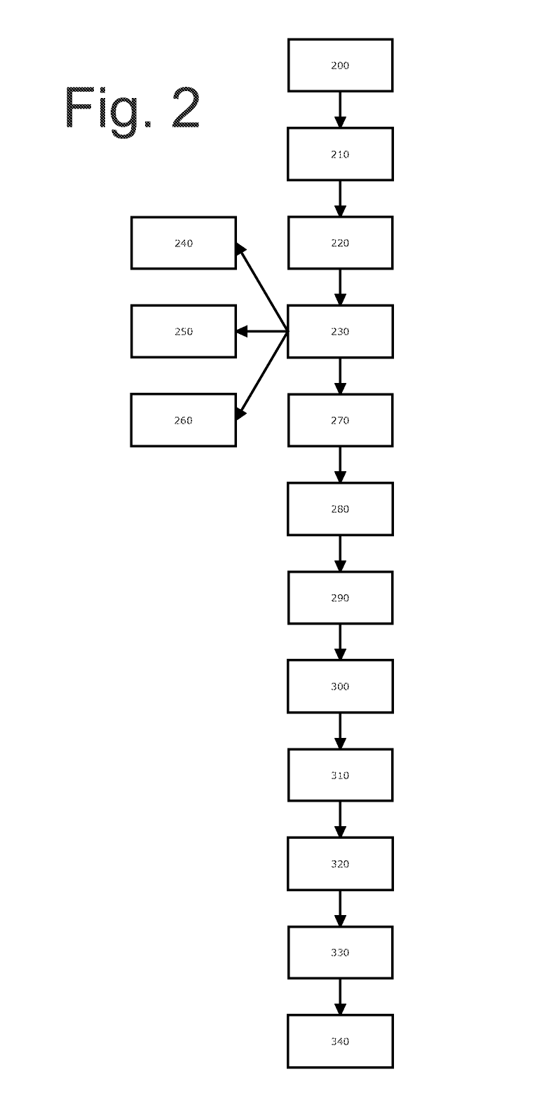

FIG. 2 relates to the system of the present invention in regard to actions taken by the charge nurse or hospital official. First, a patient will enter the emergency room seeking assistance (200). The official will be in possession of the spreadsheet (5) and will place a sticker (either real or electronic if done on a computer) onto the spreadsheet (5) indicating the patient's identity (210), and notate where the patient is initially located (220). The official will then notate the name of the admitting doctor, as well as any diagnosis and special needs of the patient (230). In addition, the official will notate such special items as private room (240), CA/TB concerns (250), and C-diff/MRSA concerns (260). Once the emergency room doctor admits the patient, the official will notate the time admitted by the emergency room doctor (270). From there, the official will notate on the spreadsheet (5) the time the NS was called (280). Once a room is assigned to the patient, the official will notate the room number (290) onto the spreadsheet (5), as well as notate the time that room was assigned (300). The official will then notate the time admission orders are made (310) as well as the time those admission orders are faxed or transmitted (320) to the appropriate place. The official will then notate the time the patient was actually transferred to the floor (330). A delay code is marked (340) when delays occur for this final admission point. During each step in the process of the present invention, the official or charge nurse will be able to track in real time the status of not only multiple patients, but also where bottlenecks and holdups occur.

In the preferred embodiment, the present invention should be understood to be a patient admission tracking system, comprising entering, on a computer, the identity of a patient in a first box; marking, on a computer, the location of the patient in a second box; designating, on a computer, an admitting doctor, a diagnosis, or special needs in a third box; entering, on a computer, a time that the patient is admitted in a fourth box; and indicating, on a computer, the time that a hospital room is assigned in a fifth box. Further, the present invention comprises providing, on a computer, a time admission orders are made in a sixth box. Also, the present invention comprises entering, on a computer, a time admission orders are faxed in a seventh box. As well, the present invention comprises entering, on a computer, a time the patient was transferred to a hospital floor in an eighth box. Moreover, the present invention comprises marking, on a computer, when a delay occurs in a transfer to a hospital floor. Also, the present invention comprises alerting as to when a blank space in the first box exists but the second box has been marked.

1. A patient admission tracking system, comprising:
Entering, on a computer, the identity of a patient in a first box;
Marking, on a computer, the location of the patient in a second box;
Designating, on a computer, an admitting doctor, a diagnosis, or special needs in a third box;
Entering, on a computer, a time that the patient is admitted in a fourth box; and
Indicating, on a computer, the time that a hospital room is assigned in a fifth box.

2. The patient admission tracking system of claim 1, further comprising:
Providing, on a computer, a time admission orders are made in a sixth box.

3. The patient admission tracking system of claim 1, further comprising:
Entering, on a computer, a time admission orders are faxed in a seventh box.

4. The patient admission tracking system of claim 1, further comprising:
Entering, on a computer, a time the patient was transferred to a hospital floor in an eighth box.

5. The patient admission tracking system of claim 1, further comprising:
Marking, on a computer, when a delay occurs in a transfer to a hospital floor.

6. The patient admission tracking system of claim 1, further comprising:
Alerting as to when a blank space in the first box exists but the second box has been marked.
